(19) United States
(12) Patent Application Publication
(10) Pub. No.: US 2021/0287071 A1
(43) Pub. Date: Sep. 16, 2021

(54) Method and Apparatus for Augmented Data Anomaly Detection

(71) Applicant: Morgan State University, Baltimore, MD (US)

(72) Inventors: Mariem Ben Fadhel, Redmond, WA (US); Kofi Nyarko, Millersville, MD (US)

(21) Appl. No.: 17/200,606

(22) Filed: Mar. 12, 2021

Related U.S. Application Data
(60) Provisional application No. 62/988,442, filed on Mar. 12, 2020.

(51) Int. Cl. G06N 3/04; G06N 3/08; G06K 9/62

(52) U.S. Cl. CPC G06N 3/0454; G06K 9/6267; G06N 3/088

(57) ABSTRACT

A data anomaly detection method and apparatus in which a deep neural network is trained on baseline data. Sequences of statistics of each layer of the deep neural network are saved, processed and used to train an LSTM autoencoder across a variety of reconstruction error thresholds, and a preferred threshold is selected for an optimized autoencoder. In an Inference mode, a data sample is presented to the autoencoder; the reconstruction error is calculated and compared to the threshold. If it is above the threshold, then the data sample is an out-of-distribution sample, and the sample is tagged as anomalous.

### BACKGROUND OF THE INVENTION

### Field of the Invention

The present invention relates to identifying anomalous data, including malicious text data that can be embedded in text documents, based on a certain set of measures.

### Description of the Background

Generative adversarial networks (GAN) are a class of machine learning frameworks in which two neural networks contest with each other in a zero-sum game, where one agent's gain is another agent's loss.

Given a training set, this technique learns to generate new data with the same statistics as the training set. For example, a GAN trained on photographs can generate new photographs that look at least superficially authentic to human observers, having many realistic characteristics. Though originally proposed as a form of generative model for unsupervised learning, GANs have also proven useful for semi-supervised learning, fully supervised learning, and reinforcement learning.

The core idea of a GAN is based on the “indirect” training through the discriminator, which itself is also being updated dynamically. This basically means that the generator is not trained to minimize the distance to a specific image, but rather to fool the discriminator. This enables the model to learn in an unsupervised manner.

The generative network generates candidates while the discriminative network evaluates them. The contest operates in terms of data distributions. Typically, the generative network learns to map from a latent space to a data distribution of interest, while the discriminative network distinguishes candidates produced by the generator from the true data distribution. The generative network's training objective is to increase the error rate of the discriminative network (i.e., “fool” the discriminator network by producing novel candidates that the discriminator thinks are not synthesized (are part of the true data distribution)).

A known dataset serves as the initial training data for the discriminator. Training it involves presenting it with samples from the training dataset, until it achieves acceptable accuracy. The generator trains based on whether it succeeds in fooling the discriminator. Typically, the generator is seeded with randomized input that is sampled from a predefined latent space (e.g., a multivariate normal distribution). Thereafter, candidates synthesized by the generator are evaluated by the discriminator. Independent backpropagation procedures are applied to both networks so that the generator produces better images, while the discriminator becomes more skilled at flagging synthetic images. The generator is typically a deconvolutional neural network, and the discriminator is a convolutional neural network.

The problem of applying GAN networks to anomaly detection is attracting increasing interest. GANs are superior to other generative models like autoencoders or variational autoencoder in producing realistic data. Augmenting the baseline data through the generator and training a classifier to recognize real from fake data is tempting to apply the model in the context of anomaly detection. The pitfall though is that the fake data class (K+1), K being the first labeled classes (K could be 1 in the case of a binary classifier), does not represent all the unknown distributions related to the anomalous data. Also, the generator tends to match the data distribution of real samples, and in the case of feature matching, the space of real data features. It means that as the GAN is optimized, the fake distribution tends to get closer to the distribution of real samples.

There have been mainly three approaches adopted for this problem. First is leveraging the discriminator and the generator both to conduct anomaly detection. T. Schlegl, et al. present AnoGAN, an anomaly detection scheme for anomalous image detection based on identifying disease markers. T. Schlegl, P. Seebock, S. M. Waldstein, U. Schmidt-Erfurth, and G. Langs, “Unsupervised Anomaly Detection with Generative Adversarial Networks to Guide Marker Discovery.” They provide two scoring schemes, one based on a residual loss of the distance between a real image and a generated image, and a feature matching discrimination loss that computes the loss of the discriminator output on when fed a generated image. This allows deciding if an image comes from the generator distribution by a process of inverse mapping. They conclude that the residual loss is enough for the anomaly detection task.

C. Wang, et al., proposed a minimum likelihood method to force the generator to produce values that are distant from the normal distribution which is counter-intuitive to the goal of GAN which is to make the generator produce data similar to the real one. C. Wang, Y.-M. Zhang, and C.-L. Liu, “Anomaly detection via minimum likelihood generative adversarial networks,” CoRR, vol. abs/1808.00200, 2018. P. Zheng, et al. proposes a method for leveraging GANs for fraud detection in which they train a complementary generator that produces data samples in low-density areas of the data distribution and is used as a generalization method and a solution to optimize learning, this is not quite representative of anomalous data. P. Zheng, S. Yuan, X. Wu, J. Li, and A. Lu, “One-class adversarial nets for fraud detection,” CoRR, vol. abs/1803.01798, 2018.

### SUMMARY OF THE INVENTION

The invention is a framework for anomaly detection that incorporates a deep multi-layer neural network for data augmentation and classification, which improves at recognizing anomalous data with experience. The anomalous data may be detected from among any type of data collection, but the invention is especially useful for detecting text anomalies. Accordingly, there is provided according to the invention, a method for detection of data anomalies via a deep multi-layer neural network architecture, the method being implemented by a computer system that comprises one or more processors executing computer program instructions that, when executed, perform the method, the method comprising:

in a neural network training phase:
a. obtaining a first collection of actual data items corresponding to at least one group of data categories, said first collection of actual data items having a first data distribution;
b. using a first neural network to generate a set of synthetic data items using a synthetic data generation configuration;
c. providing said collection of actual data items and said set of synthetic items to a second neural network;
d. using the second neural network to (i) make a classification determination using a set of classification determination configurations including whether each data item in said set of synthetic data items is synthetic or actual, and (ii) update said set of classification determination configurations;
e. providing said classification determinations to said first neural network;
f. using said classification determinations by said first neural network to update said synthetic data generation configuration;
g. repeating steps b through f until said second neural network cannot make a valid classification determination;
h. generating autoencoder training sequences of updated classification determination configurations for each layer in said second neural network;

in an autoencoder training phase:
i. providing said autoencoder training sequences to an autoencoder, and said autoencoder training itself to differentiate anomalous from real data using said autoencoder training sequences across a range of reconstruction error thresholds;
j. selecting a preferred reconstruction error threshold based on autoencoder performance during said training step to result in said autoencoder being optimized for recognition of anomalous data;

in a data anomaly detection phase:
k. submitting to the second neural network a purported data item;
l. generating by said second neural network new sequences of classification determination configurations corresponding to said purported data item;
m. providing said new sequences to said autoencoder, said autoencoder generating a prediction as to whether said purported data item falls within said first data distribution;
n. classifying by said autoencoder said purported data item as anomalous if said purported data item falls outside said first data distribution;
o. sending said new sequences to said second neural network if said purported data item is determined by said autoencoder to fall within said first data distribution, and making a classification determination by said second neural network for said purported data item using said set of classification configurations; and
p. notifying a user that said purported data item may be anomalous if said second neural network determines that said purported data item is synthetic.

According to a preferred embodiment of the invention, the first neural network and the second neural network may be the generator and discriminator, respectively, of a generative adversarial network. According to another preferred embodiment, the data is text, and the anomalous data is malicious text.

There is further provided according to the invention, a computer system that comprises one or more processors executing computer program instructions that, when executed, cause the computer system to carry out the steps of the method set forth above.

There is further provided according to the invention, an apparatus comprising a first neural network, a second neural network and an autoencoder, each configured to carry out the steps described for them respectively in the method set forth above.

There is further provided according to the invention a method for detection of data anomalies via a deep multi-layer neural network architecture, the method being implemented by a computer system that comprises one or more processors executing computer program instructions that, when executed, perform the method, the method including the following steps:
a. training a semi-supervised neural network on a set of baseline data;
b. saving and processing sequences of statistics generated during said training step for each layer of the neural network;
c. training and validating an LSTM autoencoder using at least a portion of said processed sequences of statistics across a range of reconstruction error thresholds;
d. examining a data sample by the LSTM autoencoder and calculating the reconstruction error by the autoencoder and comparing the reconstruction error of to a selected reconstruction error threshold;
e. identifying said data sample as anomalous if the reconstruction error is above the selected reconstruction error threshold.

According to a further embodiment of the method, the set of baseline data includes at least one data category and assignments of data items to respective ones of said at least one data category; the method having the additional steps of:
f. sending said data sample to said semi-supervised neural network if said data sample is at or below the selected reconstruction error threshold, and making by said semi-supervised neural network a category determination for said data item; and
g. making by said semi-supervised neural network a determination that the data is anomalous if the category determination for said data item is fake.

While the invention is described herein with reference to various implementations and exploitations, it will be understood that these embodiments are illustrative and that the scope of the inventive subject matter is not limited to them.

### BRIEF DESCRIPTION OF THE DRAWINGS

FIG. 1 shows the framework for data anomaly detection with a generative adversarial network according to an embodiment of the invention.

FIG. 2A shows LSTM autoencoder reconstruction errors for normal/baseline statistics.

FIG. 2B shows LSTM autoencoder reconstruction errors for anomalous statistics.

FIG. 3A shows LSTM autoencoder training loss and validation loss thought epochs for anomaly detection of sequences of the discriminator's training statistics.

FIG. 3B shows an LSTM autoencoder recall vs. precision analysis for anomaly detection of sequences of the discriminator's training statistics.

FIG. 3C shows an LSTM autoencoder false positive rate for anomaly detection of sequences of the discriminator's training statistics.

FIG. 3D shows an LSTM autoencoder recall vs. reconstruction error analysis for anomaly detection of sequences of the discriminator's training statistics.

### DETAILED DESCRIPTION

The present invention addresses the problem of convergences of normal and anomalous distributions in data anomaly detection. While the present invention may be used to detect anomalies in all types of data, the invention is particularly suitable to detect anomalies in discrete non-continuous non-ordered data types, and more particularly, text data. In addition to the discrete, non-continuous, and non-ordered nature of text data, text adds more challenges for the detection of anomalies; for example, the features of text data are mostly unknown and multidimensional, and the context of each word must be accounted for to grasp the semantic meaning. The framework presented can be applied to solve problems like code authorship analysis, code injections and bot identification in social media for example. Another challenge is how to take advantage of the scarce anomalous/malicious data samples so that it is recognized in the next run of the outlier detection system.

The invention is a framework for anomaly detection that incorporates a semi-supervised neural network for data augmentation and classification, which improves at recognizing anomalous data with experience. According to one embodiment, it may be done by training a generator and a discriminator in a zero-sum game setting and minimizing the Jenson-Shannon Divergence (JSD) between the distribution of the real data and the generated data.

25 [symbol] _{GAN}= [symbol] log D(s)+ [symbol] _{z˜p}_{_{z}} log[1−D(G(z))]

Semi-supervised GANs are capable of classifying data and also generating comparable samples to real data, which could be of great use in the context of anomaly detection. It can be leveraged by recognizing known classes of data, which consist of not only the baseline classes but also known or previously encountered rare classes of malicious data and augmenting these classes by generating additional samples to optimize the classification boundaries.

In fact, Z. Dai, et al. demonstrates that the generator in a semi-supervised GAN generates data from a mixture distribution of all these classes. Z. Dai, Z. Yang, F. Yang, W. W. Cohen, and R. R. Salakhutdinov, “Good semi-supervised learning that requires a bad gan,” in Advances in Neural Information Processing Systems 30, I. Guyon, U. V. Luxburg, S. Bengio, H. Wallach, R. Fergus, S. Vishwanathan, and R. Garnett, Eds. Curran Associates, Inc., 2017, pp. 6510-6520. The challenge remaining is to alter their objective function and render them workable on discrete data in a semi-supervised context. The first line of defense, more comparable to the innate human immune system, aims to recognize out-of-distribution data that is considered anomalous.

The present invention aims to recognize out-of-distribution (abnormal) data that is considered anomalous. The invention receives a sequence of deep statistics and decides solely with batches of baseline data if it is in fact anomalous. If it is not an out-of-distribution sample, subsequent processes provide the correct class corresponding to the in-distribution sample. Conditional Semi-Supervised GAN

GANs were created initially to generate continuous samples and exhibit limitations when it comes to discrete data, as it hinders the backpropagation process. The reason being that gradient updates from the discriminator will not necessarily match a value in the discrete domain during the backward propagation of the gradients from the discriminator to the generator which is only feasible if the generated samples comes from a continuous distribution.

For comparison, a form of GAN, TextGAN, incorporates the Maximum Mean Discrepancy (MMD) to measure dissimilarity between the features of generated and real sequences. It defines the generator as a Long Short-Term Memory (LSTM) Recurrent Network (RNN) and the discriminator as a Convolutional Neural Network (CNN). The objective function is inspired by the feature matching objective and is defined below:

[symbol]

_{G}= [symbol] _{MMD}_{²}

[symbol]

_{D}= [symbol] _{GAN}−λᵣ [symbol] _{recon}+λₘ [symbol] _{MMD}_{²}

[symbol]

_{recon}=∥\hat{z}−Z∥²

Instead of matching the real sentences, the generator attempts to match the synthetic sentence features to the real sentence features by minimizing the MMD between the two distributions. [symbol] _{recon} is the reconstruction loss, which is the distance between the latent variable and its reconstructed version. The discriminator's loss incorporates the standard GAN loss which renders the model vulnerable to mode collapse. In a comparative study provides an analysis where it proves that TextGAN is, in fact, prone to mode collapse.

On the other hand, semi-supervised generative adversarial learning has proven to produce more stability in training and to provide a significant improvement with regards to the quality of generated samples.

Given a corpus of sequences [symbol] , a labeled set of sequences [symbol] =(s,y) and [symbol] =1, 2, . . . , K label space for classification with K being the number of classes, let P_{D} be the distribution corresponding to the discriminator and P_{G} be the distribution corresponding to the generator.

The discriminator loss of a GAN over sequences of discrete elements is:

[symbol]

_{D}= [symbol] _{DSSL}−λᵣ [symbol] _{recon}+λₘ [symbol] _{MMD}_{²}

[symbol]

_{DSSL}= [symbol] log P_{D}(y|s,y≤K)+ [symbol] log P_{D}(y≤K)+ [symbol] _{\tilde{s}˜G} log P_{G}(K+1|\tilde{s})

The first term is the log conditional probability for labeled sequences. The second term is the log probability for the K classes. Notice that it is not conditioned because it concerns the unlabeled sequences. Finally, the last term is the conditional log probability of generated data, s being the synthetic sequence generated by G.

In order to optimize the objective function, the discriminator's loss function is maximized, and the generator's loss function is minimized.

### Anomaly Detection Module

Neural networks are easily misled by adversarial examples due to their linearity. Those are data points that had been perturbed as to incur an erroneous classification with high confidence. This fact is rather alarming in a world that is increasingly relying on artificial intelligence and machine learning for crucial tasks.

According to the method for anomaly detection of the invention, the patterns of sequences collected from the output statistics at each layer of the discriminator are analyzed to ascertain whether they provide a reliable detection of out-of-distribution samples. Let Vᵢ be the vector output of layer 1, Vᵢ=logitᵢ with values from logits at layer 1. Let SV_{S} be the sequence of vectors Vᵢ for a data sample s from [symbol] . An LSTM autoencoder neural network is trained on batches of sequences SVₛ. Autoencoders are feed-forward neural networks that are trained to learn the most important features that lead to generating an almost identical copy of the input. Its objective is to minimize the loss of reconstructing the input using backpropagation, called the reconstruction error. A high reconstruction error of a sample signals that sequence of statistics is anomalous. The threshold marking the limit of acceptable reconstruction error can also be learned based exclusively on baseline samples. An advantage of autoencoders is that the deviation from benign input is possible without the introduction of malicious data, which fits the problem of anomaly detection. The autoencoder framework had been extensively used for anomaly detection.

### Data Anomaly Detection Framework

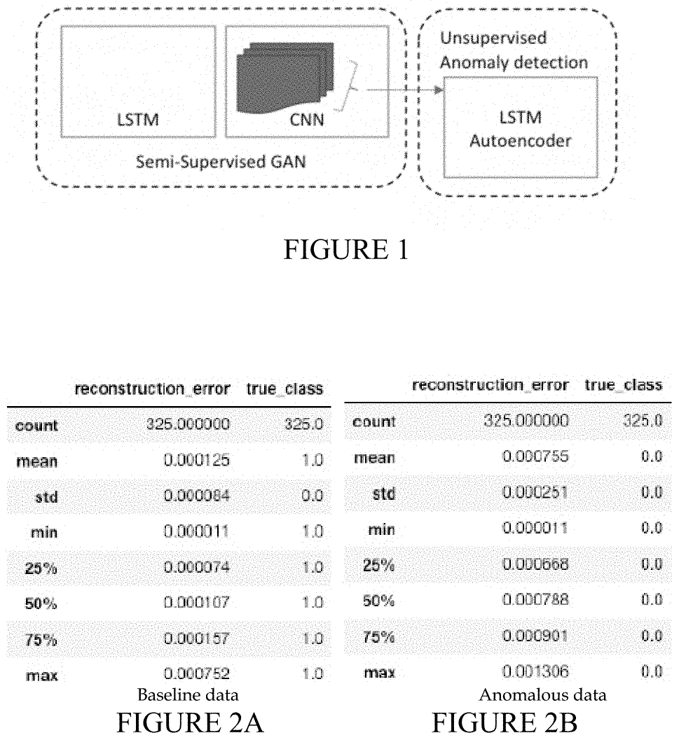

The data anomaly detection framework works as follows: a deep neural network, for example, but not limited to, a semi-supervised GAN, is trained on baseline data. Sequences of statistics of each layer of the discriminator are saved and prepared (normalized and scaled, and in the case of text, embedded) to train the LSTM autoencoder. The LSTM autoencoder is trained and validated using at least a portion of the statistics' sequences. At this point, the reconstruction error threshold is adjusted. In the Inference mode, the process starts with the LSTM autoencoder. To check if a data sample is malicious, the reconstruction error of the autoencoder is calculated and compared to the threshold. If it is above the threshold, then the data sample is an out-of-distribution sample and there is no need to go further. It is tagged as anomalous. If it is less than the threshold, the last column that corresponds to the softmax layer is injected into the last layer of the discriminator to get the class it corresponds to. FIG. 1 depicts the components of the data anomaly detection framework according to one embodiment of the invention.

### Examples

The anomaly detection model is trained on two datasets, namely, the sentence polarity dataset, which consists of 1000 positive and 1000 negative movie reviews, and a 20Newsgroups dataset comprised of 20,000 news group documents. It is a popular dataset for machine learning experiments on text data. It begins with training a Convolutional Neural Network. The standard splitting of data into training, validation and testing sets is employed, with a ratio of 0.6, 0.2, 0.2 respectively. 20Newsgroups is set as the baseline whereas the polarity dataset is the malicious dataset. The latter is only used to test the model, it is not part of the training process, and the anomaly detection method does not depend on it.

After training the semi-supervised GAN anomaly detection model on both datasets, two news datasets are built from the discriminator network's layers. The architecture used is disclosed in Y. Zhang, Z. Gan, K. Fan, Z. Chen, R. Henao, D. Shen, and L. Carin, “Adversarial feature matching for text generation,” arXiv preprint arXiv:1706.03850, 2017. Text inputs are vectorized using GloVe (Global Vectors for Word Representation) to obtain word embedding which generates a considerable size of the logits at the embedding layer. Scaling, normalization and splitting are performed on the sequences using it to train the LSTM autoencoder.

Favorable results are observed when applying the out-of-distribution component to two different data sets of sequences of discrete data. Reconstruction error is much higher for sequences coming from out-of-distribution data.

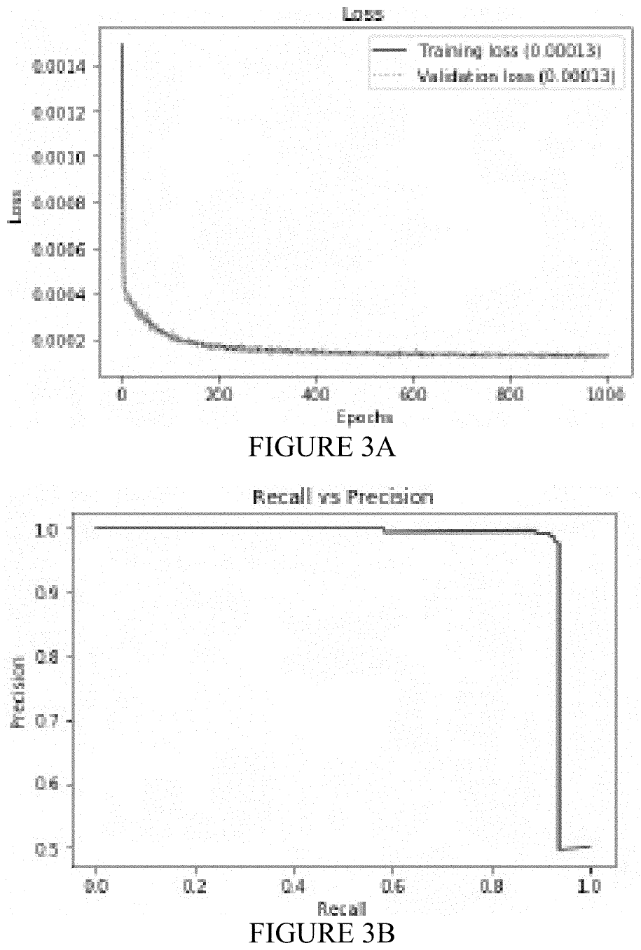

Out-of-distribution samples must trigger a higher reconstruction error if the sequences of statistics are informative of anomalous samples, and that will confirm our assumption. The reconstruction error for in- and out-of-distribution sequences of statistics are shown in FIGS. 2A and 2B. Reconstruction errors are much higher for sequences coming from out-of-distribution data than for baseline data.

The autoencoder is trained in an unsupervised way, but for the sake of validating our assumption, the sequences of the statistics collected from each layer in the discriminator's network and that were used to train the LSTM autoencoder were labeled as one class, the ones coming from a different distribution as another. The receiver operating curve is used to visualize the performance of a classifier. It shows the true positive rate versus the false positive rate under different thresholds. A steeper curve goes along with a better performance. The recall and precision are the defined as:

$$Precision = \frac{TruePositives}{TruePositives + FalsePositives}$$

$$Recall = \frac{TruePositives}{TruePositives + FalseNegatives}$$

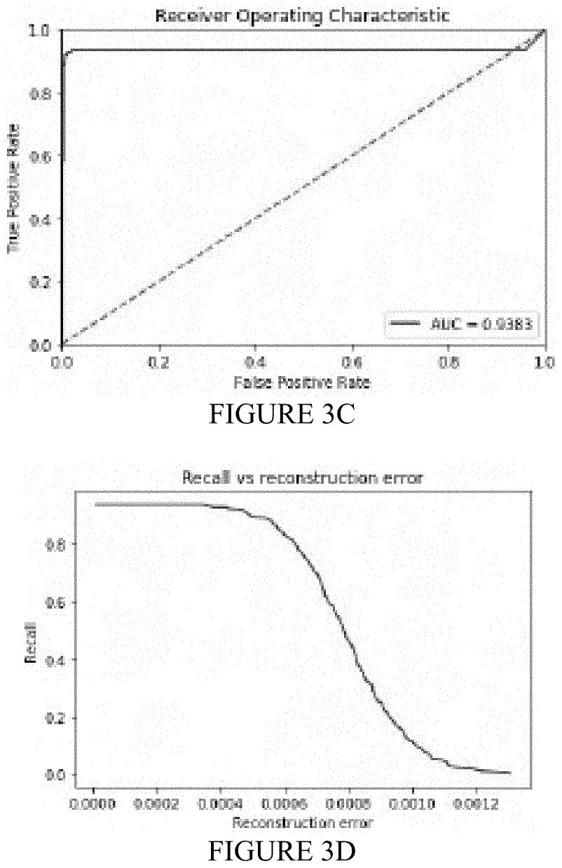

A high value of recall and precision is the goal, and it means that many correct predictions are returned and have high relevance. The recall is plotted with respect to the reconstruction error under different thresholds. These plots give us a fair idea on the optimal value of threshold to detect anomalous samples. Based on that threshold, the confusion matrix is visualized to test if the threshold is adequate in generating an acceptable number of erroneous predictions. FIGS. 3a-3D show the results of the analysis.

While the examples above are described with reference to various implementations and exploitations, specifically to detection of anomalous text data, it will be understood that these examples are illustrative and that the scope of the inventive subject matter is not limited to them. Specifically, the inventions described and claimed herein may be used to detect anomalous data of any type. Moreover, as the methods described herein may be implemented with facilities consistent with any hardware system or hardware systems. Many variations, modifications, additions, and improvements are possible.

1. A method for detection of data anomalies via a deep multi-layer neural network architecture, the method being implemented by a computer system that comprises one or more processors executing computer program instructions that, when executed, perform the method, the method comprising:
in a neural network training phase:
a. obtaining a first collection of actual data items corresponding to one or more groups of data categories, said first collection of actual data items having a first data distribution;
b. using a first neural network to generate a set of synthetic data items using a synthetic data generation configuration;
c. providing said collection of actual data items and said set of synthetic items to a second neural network;
d. using the second neural network to (i) make a classification determination using a set of classification determination configurations including whether each data item in said set of synthetic data items is synthetic or actual, and (ii) update said set of classification determination configurations;
e. providing said classification determinations to said first neural network;
f. using said classification determinations by said first neural network to update said synthetic data generation configuration;
g. repeating steps b through f until said second neural network cannot make a valid classification determination;
h. generating autoencoder training sequences of updated classification determination configurations for each layer in said second neural network;
in an autoencoder phase:
i. providing said autoencoder training sequences to an autoencoder, and said autoencoder training itself to differentiate anomalous data from real data using said autoencoder training sequences across a range of reconstruction error thresholds;
j. selecting a preferred reconstruction error threshold based on autoencoder performance during said training step to result in said autoencoder being optimized for recognition of anomalous data;
in a data anomaly detection phase:
k. submitting to the second neural network a purported data item;
l. generating by said second neural network new sequences of classification determination configurations corresponding to said purported data item;
m. providing said new sequences to said autoencoder, said autoencoder generating a prediction as to whether said purported data item falls within said first data distribution;
n. classifying by said autoencoder said purported data item as anomalous if said purported data item falls outside said first data distribution;
o. sending said new sequences to said second neural network if said purported data item is determined by said autoencoder to fall within said first data distribution, and making a classification determination by said second neural network for said purported data items using said set of classification configurations; and
p. notifying a user that said purported data item may be anomalous if said second neural network determines that said purported data item is synthetic.

2. A method according to claim 1, wherein said first neural network and said second neural network are a generator and a discriminator, respectively, of a generative adversarial network.

3. A method according to claim 1, wherein said actual data is text data and said anomalous data is malicious text.

4. A system comprising:
a computer system that comprises one or more processors executing computer program instructions that, when executed, cause the computer system to:
in a neural network training phase:
a. obtain a first collection of actual data items corresponding to one or more groups of data categories, said first collection of actual data items having a first data distribution;
b. use a first neural network to generate a set of synthetic data items using a synthetic data generation configuration;
c. provide said collection of actual data items and said set of synthetic items to a second neural network;
d. use the second neural network to (i) make a classification determination using a set of classification determination configurations including whether each data item in said set of synthetic data items are synthetic or actual, and (ii) update said set of classification determination configurations;
e. provide said classification determinations to said first neural network;
f. use said classification determinations by said first neural network to update said synthetic data generation configuration;
g. repeat steps b through f until said second neural network cannot make a valid classification determination;
h. generating autoencoder training sequences of updated classification determination configurations for each layer in said second neural network;
in an autoencoder training phase:
i. provide said autoencoder training sequences to an autoencoder to train itself to differentiate anomalous data from real data using said autoencoder training sequences across a range of reconstruction error thresholds;
j. select a preferred reconstruction error threshold based on autoencoder performance during said training step to result in said autoencoder being optimized for recognition of anomalous data;
in a data anomaly detection phase:
k. submit to the second neural network a purported data item;
l. generate by said second neural network new sequences of classification determination configurations corresponding to said purported data item;
m. provide said new sequences to said autoencoder, and generate by said autoencoder a prediction as to whether said purported data item falls within said first data distribution;
n. classify by said autoencoder said purported data item as anomalous if said purported data item falls outside said first data distribution;
o. send said new sequences to said second neural network if said purported data item is determined by said autocoder to fall within said first data distribution, and make a classification determination by said second neural network for said purported data item using said set of classification configurations;
p. notify a user that said purported data item may be anomalous or malicious if said second neural network determines that said purported data item is synthetic.

5. A system according to claim 4, wherein said first neural network and said second neural network are a generator and a discriminator, respectively of a generative adversarial network.

6. A system according to claim 4, wherein said actual data is text data, and said anomalous data is malicious text.

7. An apparatus comprising:
a first neural network configured to
a. generate a set of synthetic data items using a synthetic data generation configuration; and
b. provide a collection of actual text data items and said set of synthetic items to a second neural network, said collection of actual text data items having a first data distribution;
a second neural network configured to
(i) make a classification determination using a set of classification determination configurations whether each data item in said set of synthetic data items are synthetic or actual data,
(ii) make a classification determination for each data item in said set of synthetic data items and said collection of actual data items using a set of classification configurations; and
(iii) update said set of classification determination configurations;
(iv) provide said classification determinations to said first neural network;
said first neural network further configured to:
c. use said classification determinations by said second neural network to update said synthetic data generation configuration;
said second neural network further configured to:
(v) generate autoencoder training sequences of updated classification determination configurations for each layer in said second neural network,
said system further comprising an autoencoder configured to
1) use auto encoder training sequences to train itself to differentiate anomalous data from real data across a range of reconstruction error thresholds;
2) select a preferred reconstruction error threshold based on autoencoder performance to result in said autoencoder being optimized for recognition of anomalous data;
said second neural network further configured to:
(vi) generate new sequences of classification determination configurations corresponding to a purported data item and provide said new sequences to said autoencoder;
said autoencoder further configured to:
3) generate a prediction using said new sequences as to whether said purported data item falls within said first data distribution;
4) classify said purported data item as anomalous if said purported data item falls outside said first data distribution;
5) send said new sequences to said second neural network if said purported data item is determined to fall within said first data distribution.

8. An apparatus according to claim 7, wherein said first neural network and said second neural network are a generator and a discriminator, respectively, of a generative adversarial network.

9. An apparatus according to claim 7, wherein said data is text data and said anomalous data is malicious text.

10. A method for detection of data anomalies via a deep multi-layer neural network architecture, the method being implemented by a computer system that comprises one or more processors executing computer program instructions that, when executed, perform the method, the method comprising:
a. training a semi-supervised neural network on a set of baseline data;
b. saving and processing sequences of statistics generated during said training step for each layer of the neural network;
c. training and validating an LSTM autoencoder using at least a portion of said processed sequences of statistics across a range of reconstruction error thresholds;
d. examining a data sample by the LSTM autoencoder and calculating the reconstruction error by the autoencoder and comparing the reconstruction error of to a selected reconstruction error threshold;
e. identifying said data sample as anomalous if the reconstruction error is above the selected reconstruction error threshold.

11. A method according to claim 10 wherein the set of baseline data includes at least one data category and assignments of data items to respective ones of said at least one data category; the method further comprising:
f. sending said data sample to said semi-supervised neural network if said data sample is at or below the selected reconstruction error threshold, and making by said semi-supervised neural network a category determination for said data item;
g. making by said semi-supervised neural network a determination that the data is anomalous if the category determination for said data item is fake.

12. A method according to claim 10, wherein said semi-supervised neural network is a discriminator.

13. A method according to claim 10, wherein said baseline data is actual text data and said sample data is purported text data.
